(19) United States
(12) Patent Application Publication
(10) Pub. No.: US 2012/0320772 A1
(43) Pub. Date: Dec. 20, 2012

(54) COMMUNICATION DEVICES FOR TRANSMITTING DATA BASED ON AVAILABLE RESOURCES

(75) Inventors: Guido Robert Frederiks, Aptos, CA (US); James S. Cho, Mountain View, CA (US)

(73) Assignee: QUALCOMM Incorporated, San Diego, CA (US)

(21) Appl. No.: 13/494,415

(22) Filed: Jun. 12, 2012

Related U.S. Application Data
(60) Provisional application No. 61/497,007, filed on Jun. 14, 2011.

(51) Int. Cl. H04W 72/00

(52) U.S. Cl. 370/252

(57) ABSTRACT

A method for transmitting data by a communication device is described. The method includes determining whether there are sufficient resources available to insert data into an aggregated packet. The method also includes inserting discardable data into the aggregated packet if there are not sufficient resources available to insert the data. The method further includes inserting the data into the aggregated packet if there are sufficient resources available to insert the data.

### RELATED APPLICATIONS

This application is related to and claims priority from U.S. Provisional Patent Application Ser. No. 61/497,007 filed Jun. 14, 2011, for “MANAGING RESOURCE SHORTAGES FOR TRANSMIT DATA ON AN ELECTRONIC DEVICE.”

### TECHNICAL FIELD

The present disclosure relates generally to electronic devices. More specifically, the present disclosure relates to communication devices for transmitting data based on available resources.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform functions faster, more efficiently or with higher quality are often sought after.

Some electronic devices (e.g., cellular phones, smart phones, computers, etc.) communicate with other electronic devices. These electronic devices may be referred to as communication devices. These electronic devices may generate and transmit data to other electronic devices. For example, a laptop computer may format data into packets and wirelessly transmit the packets to an access point.

Additional capacity in a communicated signal is often sought after. For example, communication device users may desire increased communication speeds. However, utilizing additional communication capacity may often require increased device resources. As can be observed from this discussion, systems and methods that manage resource usage may be beneficial.

### BRIEF DESCRIPTION OF THE DRAWINGS

FIG. 1 is a block diagram illustrating one configuration of a communication device in which systems and methods for transmitting data based on available resources may be implemented;

FIG. 2 is a flow diagram illustrating one configuration of a method for transmitting data based on available resources by a communication device;

FIG. 3 is a diagram illustrating examples of aggregated packets;

FIG. 4 is a block diagram illustrating one example of an access point in which systems and methods for transmitting data based on available resources may be implemented;

FIG. 5 is a diagram illustrating additional examples of aggregated packets;

FIG. 6 is a block diagram illustrating a more specific configuration of a communication device in which systems and methods for transmitting data based on available resources may be implemented;

FIG. 7 is a flow diagram illustrating one configuration of a method for transmitting data based on available resources by a communication device;

FIG. 8 illustrates certain components that may be included within a wireless communication device; and

FIG. 9 illustrates certain components that may be included within an access point.

### DETAILED DESCRIPTION

The systems and methods disclosed herein may be applied to a variety of electronic devices. Examples of electronic devices include voice recorders, video cameras, audio players (e.g., Moving Picture Experts Group-1 (MPEG-1) or MPEG-2 Audio Layer 3 (MP3) players), video players, audio recorders, desktop computers, laptop computers, personal digital assistants (PDAs), gaming systems, etc. One kind of electronic device is a communication device, which may communicate with another device. Examples of communication devices include telephones, laptop computers, desktop computers, cellular phones, smartphones, wireless or wired modems, e-readers, tablet devices, gaming systems, cellular telephone base stations or nodes, access points, wireless gateways and wireless routers, etc.

An electronic device or communication device may operate in accordance with certain industry standards, such as International Telecommunication Union (ITU) standards and/or Institute of Electrical and Electronics Engineers (IEEE) standards (e.g., Wireless Fidelity or “Wi-Fi” standards such as 802.11a, 802.11b, 802.11g, 802.11n and/or 802.11ac). Other examples of standards that a communication device may comply with include IEEE 802.16 (e.g., Worldwide Interoperability for Microwave Access or “WiMAX”), Third Generation Partnership Project (3GPP), 3GPP Long Term Evolution (LTE), Global System for Mobile Telecommunications (GSM) and others (where a communication device may be referred to as a User Equipment (UE), Node B, evolved Node B (eNB), mobile device, mobile station, subscriber station, remote station, access point, station, access terminal, mobile terminal, terminal, user terminal, subscriber unit, etc., for example). While some of the systems and methods disclosed herein may be described in terms of one or more standards, this should not limit the scope of the disclosure, as the systems and methods may be applicable to many systems and/or standards.

It should be noted that some communication devices may communicate wirelessly and/or may communicate using a wired connection or link. For example, some communication devices may communicate with other devices using an Ethernet protocol. The systems and methods disclosed herein may be applied to communication devices that communicate wirelessly and/or that communicate using a wired connection or link. In some configurations, the systems and methods disclosed herein may be applied to a communication device that communicates with another device using a satellite.

The systems and methods disclosed herein describe communication devices for transmitting data based on available resources. This may allow managing resource shortages for transmit data on communication devices. For example, the systems and methods disclosed herein may provide transmit data fetch latency handling. Due to ever-increasing packet transmission data rates, the transmission time of individual frames over a medium has been decreasing. These times have become so short that the transmit overhead in between transmissions has started to negatively effect overall network throughput capacity.

To ameliorate this inefficiency, packet aggregation techniques have been introduced, where multiple frames are aggregated together into a larger single transmission. For example, wireless local area network (e.g., WLAN, IEEE 802.11) aggregation techniques may be used. For instance, multiple frames (e.g., data frames) may be combined to form an aggregated packet.

Some overhead data may accompany a frame of data in order to describe the frame. In some configurations, the overhead data may be referred to as a descriptor and the (data) frame may be referred to as a Media Access Control (MAC) Protocol Data Unit (MPDU). Additionally or alternatively, the aggregated packet may be referred to as an Aggregated Media Access Control Protocol Data Unit (A-MPDU). For example, descriptors may contain information about the next MAC Protocol Data Unit (MPDU) in the aggregate. It should be noted that an aggregated packet may include one or more frames of data.

Aggregation techniques may enhance the number of frames that can be transmitted in a short amount of time. However, there is typically some overhead required to de-aggregate these frames and process each of the embedded frames on the receiver side. As long as the embedded frames are large, the overhead on a per frame basis is insignificant. But, when these embedded frames are small (e.g., transmission control protocol (TCP) acknowledgement (ACK) frames), the overhead of handling these small frames can become problematic, and a receiver may not be able to keep up with the rate of frames coming in.

To solve this, a receiver may indicate the density of the frames to be received. The transmitter may ensure that this density rule is met at all times. To do this, it may insert dummy filler information (e.g., dummy frame delimiter(s)) in between the frames. In the WLAN protocol, these are called null descriptors or delimiters. The dummy filler information (e.g., null descriptors) has thus far been used to solve frame density challenges on the receiver side.

Particular challenges may arise on the transmit side. For example, there is typically a certain amount of overhead associated with the processing of a single frame on the transmit side. In the case of the transmit side, however, frames need to be fetched from memory, and a requirement of reprogramming direct memory access (DMA) engines in between frames may cause latency problems, for instance. This can result in a media access control (MAC) layer not being able to keep up with the physical (PHY) layer rate. This situation may be referred to as data underflow (e.g., MAC-to-PHY underflow).

There are several approaches to solving this problem. When smaller frames are transmitted, for example, the PHY rate may be limited so that no MAC-to-PHY data underflow conditions occur. Additionally or alternatively, dummy filler or discardable data (e.g., null descriptors) may be inserted in between frames to increase the time between the frames. Adding discardable data can end when enough data for the next frame has been fetched. Other examples of discardable data may include a Quality of Service (QoS) null frame and a media access control (MAC) protocol data unit (MPDU)—like frame with an intentionally corrupted cyclic redundancy check (CRC).

The addition of discardable data can be either static (e.g., predetermined) or dynamic. For example, it may be dynamic when used as a non-destructive recovery/adaptation mechanism for when sudden large bus latencies are experienced for fetching media access control (MAC) data out of memory. In one configuration, for instance, overhead data and frames may be generated and sent when there are sufficient resources available to insert data into a packet (e.g., when there is no need for discardable data). However, a data underflow condition with one or more frames may be prevented or avoided by inserting discardable data in between frames (when there are not sufficient resources, for example).

In one configuration, regular transmissions may continue while no discardable data is needed. However, discardable data may be inserted when unexpectedly larger bus latencies, other overhead or resource shortages in between frames are experienced, for example. Instead of aborting the transmission, the transmission may be continued, but discardable data may be inserted (until enough data of the next frame is fetched to safely transmit again, for instance). In one example, three frames instead of four may get transmitted in the same amount of medium time. While this is not ideal, at least these three frames were transmitted that could be correctly received. Furthermore, internal bus problems may not result in aborted transmissions. This example describes an adaptive/dynamic system that is able to handle sudden (and typically rare) decreases in overall throughput from resource shortages (e.g., in the overall bus system and/or other resources).

Some electronic devices may use multi-user multiple input and multiple output (MU-MIMO). MU-MIMO has created more and stricter requirements on device resources (e.g., bus latencies). In one example, MU-MIMO transmissions may be sent to three devices (e.g., wireless communication devices, stations, user equipments (UEs), etc.) in parallel. Especially during the first frame transmission, data for three frames (e.g., Media Access Control (MAC) Protocol Data Units (MPDUs)) need to have been fetched and will go out in parallel. This may demand possibly three times as much startup/initialization time when compared to a single user transmission. In order to relax these requirements, or to allow more flexibility in being able to handle (unexpected) worst case variations in bus latencies, for example, discardable data may be used during transmission.

In an example with multi-user multiple input and multiple output (MU-MIMO) transmissions to three devices in parallel, discardable data may be inserted to cover transmit latencies. In this example, discardable data at the start of transmission flows for the second and third devices are used to relax or cover initial data start fetch times for the different devices. As with single user transmissions, the usage of the discardable data may be pre-calculated based on overall system knowledge. This is considered to be a ‘static’ approach. Alternatively, discardable data may be inserted dynamically during transmission, when an (unexpectedly) longer data fetch time then normal was experienced. Instead of aborting the transmission or having a corrupted data transmission, the discardable data may be inserted at a “last moment” to alleviate these potential problems. Using a dynamic approach creates an extra amount of robustness in the transmitting device.

The usage of a static and/or dynamic approach may be detected on the medium when observing multiple frame packet transmissions. When discardable data are observed consistently and in same amounts in the same spots with the same packet sizes, the static mechanism is invoked. A dynamic approach may be indicated when the usage of discardable data changes from one transmission to another with the same data sizes (sometimes none, and other times more). Thus, the systems and methods disclosed herein may allow statically or dynamically inserting discardable data (e.g., dummy frame delimiters similar to null delimiters in WLAN) during transmissions when data underflow scenarios in between frames are expected or about to occur.

In some configurations, a combination of static and dynamic approaches may be implemented. For example, a communication device may switch between static and dynamic approaches. For instance, a communication device may determine to switch between static and dynamic approaches based on conditions on the communication device (e.g., transmission data type, applications currently running, processor load, memory load, bus load, buffer load, number of concurrent aggregated packets, etc.) and/or input (from another device (e.g., receiving device) and/or a user). Additionally or alternatively, a hybrid of static and dynamic approaches may be implemented. For example, a static approach may be applied for certain transmission data types, while a dynamic approach may be applied for other transmission data types.

Various configurations are now described with reference to the Figures, where like element names may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

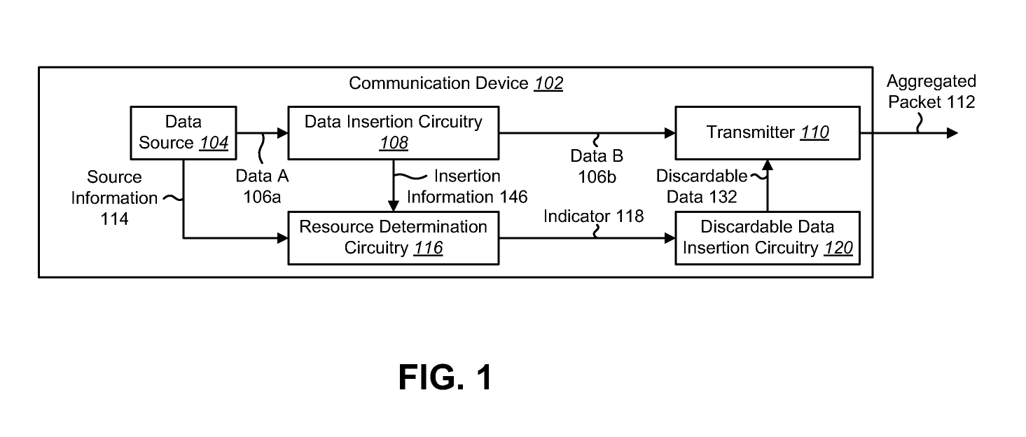

FIG. 1 is a block diagram illustrating one configuration of a communication device 102 in which systems and methods for transmitting data based on available resources may be implemented. Examples of the communication device 102 include wireless communication devices, base stations, access points, smart phones, laptop computers, desktop computers, tablet devices, gaming systems, e-readers, personal digital assistants, netbooks, wireless routers, etc. The communication device 102 may include a data source 104, data insertion circuitry 108, resource determination circuitry 116, discardable data insertion circuitry 120 and/or one or more transmitters 110.

Examples of the data source 104 include memory (e.g., double data rate (DDR) memory), processors (e.g., application processors), ports or interfaces (e.g., Ethernet ports/interfaces, advanced extensible interfaces (AXIs), universal serial bus (USB) ports, infrared (IR) ports, etc.), receivers (e.g., Bluetooth receivers, near-field communication (NFC) receivers, Wi-Fi receivers, etc.), image sensors (e.g., cameras), microphones, interfaces, etc. The data source 104 may supply data A 106a to the data insertion circuitry 108. For example, data A 106a may be payload data for transmission to another device. Data A 106a may be carried on a data bus to data insertion circuitry 108.

In some configurations, the data source 104 may provide source information 114 to the resource determination circuitry 116. The source information 114 may be one or more types of information regarding the data source 104 and/or data utilized by the data source 104. For example, the source information 114 may specify an amount of data designated for transmission, how full the data source 104 is (e.g., an amount of occupied memory), a loading factor (e.g., memory load, processor load), output rate, access speed, an indicator specifying that access speeds are slowing down or are anticipated to slow down, processes/applications currently running, one or more designated transmission data destinations (e.g., information that identifies destination devices such as Internet Protocol (IP) addresses, Media Access Control (MAC) addresses, session information, etc.), a number of transmission data destinations, anticipated packet size, temperature, etc.

The data insertion circuitry 108 may be circuitry that inserts data A 106a into one or more packets for transmission. For example, the data insertion circuitry 108 may be a first in first out (FIFO) buffer. The data insertion circuitry 108 may insert data A 106a into one or more packets (e.g., aggregated packets). Data A 106a may be inserted into one or more packets along with overhead data (e.g., descriptors). The data insertion circuitry 108 may provide data B 106b to the transmitter 110 for transmission. It should be noted that data B 106b may include all of or a subset of data A 106a. In addition, data B 106b may include overhead data (e.g., descriptors, packet headers, etc.).

The data insertion circuitry 108 may provide insertion information 146 to the resource determination circuitry 116. The insertion information 146 may be one or more types of information regarding data insertion. For example, the insertion information 146 may specify a first in first out (FIFO) buffer load (e.g., how empty or full the FIFO buffer is), input rate, output rate, bus latency, packet size, number of frames, number of aggregated packets, number of packet destinations, an amount of overhead data, a ratio of overhead data to payload data, etc.

The resource determination circuitry 116 may determine whether there are sufficient resources available to insert data (e.g., payload data) into one or more aggregated packets. Examples of resources include bus bandwidth, memory bandwidth, processor bandwidth and/or fetched data, etc. This determination may be made based on the source information 114, the insertion information 146, and/or other information. For example, the resource determination circuitry 116 may determine that there are not sufficient resources available to insert data into an aggregated packet if the data bus on the communication device 102 cannot fetch data fast enough to insert data, if there is insufficient memory currently available to insert data, if a processor's current load is too high to insert data, when data for a frame cannot be generated (e.g., calculated) rapidly enough to be inserted, if not enough data has been fetched for a frame, etc.

For example, the resource determination circuitry 116 may receive a FIFO buffer load (e.g., how much data is in the FIFO buffer, a percentage load, etc.) as insertion information 146. If the FIFO buffer load is below a threshold (e.g., less than a particular amount of data or under a percentage), then the resource determination circuitry 116 may determine that there are not sufficient resources available to insert data (e.g., payload data) into an aggregated packet.

Additionally or alternatively, for example, the resource determination circuitry 116 may receive a memory load (e.g., an amount of occupied memory) as source information 114. The resource determination circuitry 116 may determine that there are not sufficient resources available to insert data (e.g., payload data) into an aggregated packet if the memory load is above a threshold (e.g., greater than a particular amount of data or greater than a percentage). In some configurations, the resource determination circuitry 116 may determine that there are not sufficient resources available to insert data (e.g., payload data) into an aggregated packet if the memory is occupied by one or more particular (memory-intensive) applications, which may be identified by the source information 114, for instance.

Additionally or alternatively, for example, the resource determination circuitry 116 may receive a percentage of overhead data (e.g., how much of the data in the FIFO is overhead data versus payload data) as insertion information 146. The resource determination circuitry 116 may determine that there are not sufficient resources available to insert data (e.g., payload data) into an aggregated packet if the percentage of overhead data is above a threshold. This may occur in cases where the data frames are relatively small, resulting in a larger percentage of overhead data, for example.

The resource determination circuitry 116 may provide an indicator 118 to the discardable data insertion circuitry 120. The indicator 118 may be based on whether there are sufficient resources available to insert data into an aggregated packet as determined by the resource determination circuitry 116. For example, the indicator 118 may indicate that there are not sufficient resources available to insert data (e.g., payload data) into an aggregated packet. Additionally or alternatively, the indicator 118 may indicate an amount of discardable data to insert.

The discardable data insertion circuitry 120 may generate and insert discardable data 132 based on the indicator 118. For example, the discardable data insertion circuitry 120 may generate and insert discardable data 132 into data B 106b (e.g., an aggregated packet) if the indicator 118 indicates that there are not sufficient resources available to insert data into the aggregated packet. For instance, the discardable data 132 may be provided to the transmitter 110, which may transmit data B 106b in combination with the discardable data 132. Examples of discardable data include dummy information, dummy packets, null delimiters, null descriptors, null frames, MPDU-like frames with corrupted CRC, etc. A device that receives the discardable data may discard the discardable data.

In some configurations and/or instances, the discardable data 132 may be inserted in between data frames. This may be beneficial in that the data (e.g., payload data) may be preserved and may be better than inserting discardable data within a data frame. However, in some configurations and/or instances, inserting discardable data may include inserting discardable data within data frames. For instance, discardable data (e.g., corrupted data) may be inserted into portions of one or more data frames when a MAC-to-PHY underflow occurs. This may be done until sufficient resources are available to insert data. Furthermore, this may be done, for example, in order to preserve aggregated packet length. In some implementations, discardable data insertion in between data frames may take priority over discardable data insertion (e.g., data corruption) within data frames.

The transmitter 110 may transmit one or more aggregated packets 112. For example, the transmitter 110 may transmit one or more aggregated packets 112 based on wireless communication technology, wired communication technology or both. For example, the communication device 102 may transmit data to one or more other devices using one or more antennas on one or more frequency bands, time slots, layers (e.g., spatial streams), etc. In other configurations of the systems and methods disclosed herein, wired communications may be used in addition to or alternatively from wireless communications. In some implementations, the communication device 102 may operate in accordance with Wi-Fi specifications. In these implementations, the transmitter 110 may wirelessly transmit one or more aggregated packets 112 using one or more antennas.

In some configurations and/or cases, discardable data 132 may be inserted after transmission has begun (e.g., during an ongoing transmission). For example, the transmitter 110 may have begun transmitting an aggregated packet 112 when the resource determination circuitry 116 determines that there are not sufficient resources available to insert data into part of the aggregated packet 112 (that has not yet been transmitted, for example). Accordingly, the discardable data insertion circuitry 120 may insert discardable data into data B 106b (at a “last moment”). This may be done instead of aborting the transmission or having a corrupted data (e.g., payload data) transmission.

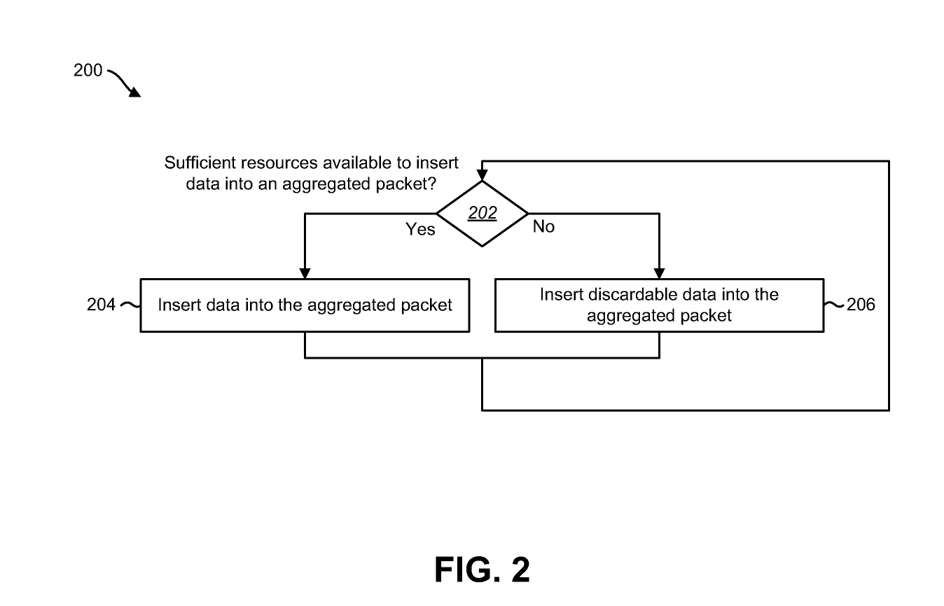

FIG. 2 is a flow diagram illustrating one configuration of a method 200 for transmitting data based on available resources by a communication device 102. A communication device 102 (e.g., base station, wireless communication device, access point, station, etc.) may determine 202 whether there are sufficient resources available to insert data (e.g., payload data) into an aggregated packet. Examples of resources include bus bandwidth, memory bandwidth, processor bandwidth and/or fetched data, etc.

For example, the communication device 102 may determine 202 whether there are sufficient resources available to insert data (e.g., payload data) into one or more aggregated packets corresponding to one or more devices. For instance, the communication device 102 may determine 202 that there are not sufficient resources available to insert data into an aggregated packet if the data bus on the communication device 102 cannot fetch data fast enough to insert data, if there is insufficient memory currently available to insert data, if a processor's current load is too high to insert data, when data for a frame cannot be generated (e.g., calculated) rapidly enough to be inserted, if enough data has not been fetched for a frame, etc. For instance, determining 202 whether there are sufficient resources available to insert data into the aggregated packet may be based on FIFO buffer load, memory load, bus latency and/or an amount (e.g., percentage) of overhead data. In some configurations, the communication device 102 may determine 202 whether there is sufficient bus bandwidth, memory bandwidth, processor bandwidth and/or fetched data, etc., to insert data into one or more aggregated packets for multiple parallel transmissions (e.g., streams, channels, etc.).

In one example, the communication device 102 may determine 202 that there are not sufficient resources available to insert data (e.g., payload data) into an aggregated packet if a FIFO buffer load is below a threshold (e.g., less than a particular amount of data or under a percentage). Additionally or alternatively, the communication device 102 may determine 202 that there are not sufficient resources available to insert data (e.g., payload data) into an aggregated packet if a memory load is above a threshold (e.g., greater than a particular amount of data or greater than a percentage). In some configurations, the communication device 102 may determine that there are not sufficient resources available to insert data (e.g., payload data) into an aggregated packet if the memory is occupied by one or more particular (memory-intensive) applications. Additionally or alternatively, the communication device 102 may determine 202 that there are not sufficient resources available to insert data (e.g., payload data) into an aggregated packet if a percentage of overhead data is above a threshold.

In some configurations, this determination 202 may be performed in the context of MU-MIMO transmissions. For example, if there are enough resources available to insert data into an aggregated packet for one receiving device but not for another receiving device, the communication device 102 may determine that there are sufficient resources available to insert data into an aggregated packet for one receiving device but not for the other (simultaneously).

If there are sufficient resources available to insert data into an aggregated packet, the communication device 102 may insert 204 data into the aggregated packet. For example, the communication device 102 may insert 204 overhead data (e.g., descriptors) and/or payload data into the aggregated packet. For instance, an access point may insert 204 a descriptor and/or data into an aggregated packet for transmission to a station. In some configurations, the data may be all or part of an MPDU.

If there are not sufficient resources available to insert data into an aggregated packet, the communication device 102 may insert 206 discardable data into the aggregated packet. For example, the communication device 102 may insert dummy information (e.g., a null delimiter, null descriptor, MPDU-like frame with corrupted CRC, etc.) into the aggregated packet. There may not be sufficient resources (e.g., insufficient resources) to insert data (e.g., payload data) into the aggregated packet when there is insufficient bus bandwidth, memory bandwidth, processor bandwidth and/or fetched data, etc.

In some configurations and/or cases, discardable data 132 may be inserted 206 after transmission has begun (e.g., during an ongoing transmission). For example, the transmitter 110 may have begun transmitting an aggregated packet 112 when the communication device 102 determines 202 that there are not sufficient resources available to insert data into part of the aggregated packet 112 (that has not yet been transmitted, for example). Accordingly, the communication device 102 may insert 206 discardable data into data B 106b (at a “last moment”). This may be done instead of aborting the transmission or having a corrupted data (e.g., payload data) transmission.

The communication device 102 may return to determine 202 whether there are sufficient resources available to insert data into an aggregated packet. In some configurations, the communication device 102 may accordingly continue to insert 206 discardable data (e.g., dummy information, null delimiters, null descriptors, etc.) into an aggregated packet if and until there are sufficient resources (e.g., bus fetching resources, memory resources, processing resources, fetched data, etc.) to insert 204 data into the aggregated packet. It should be noted that data for the aggregated packet may include overhead data (e.g., descriptors) for the frame and/or payload data. The communication device 102 may additionally transmit one or more aggregated packets to one or more devices.

In some implementations, inserting 206 discardable data into an aggregated packet may be performed based on a static approach or a dynamic approach. In one example of the static approach, predetermined amounts of discardable data may be inserted 206 based on overall system knowledge. In the static approach, the insertion 206 of discardable data may be consistently utilized. For example, if a particular memory-intensive application is running, the communication device 102 may determine 202 that there are not sufficient resources available to insert data into an aggregated packet and may insert 206 a predetermined amount of discardable data into the aggregated packet.

In a dynamic approach, the amount of discardable data inserted 206 may not be predetermined. For example, the amount of discardable data inserted 206 may vary based on available resources. For instance, the communication device 102 may determine 202 that there are not sufficient resources available to insert data (e.g., payload data) into an aggregated packet when a FIFO buffer load is below a threshold. Discardable data may be inserted 206 until the FIFO buffer load is greater than a threshold. Thus, the usage of discardable data may change from one kind of transmission to another.

In some configurations, the communication device 102 may insert 204 data and/or may insert 206 discardable data into one or more of multiple aggregated packets. This may be done when the communication device 102 is concurrently transmitting on one or more frequency bands, layers (e.g., spatial streams) and/or channels to a single device or multiple devices, for example. In some cases, the communication device 102 may selectively insert 204 data into an aggregated packet for one receiving device, but may not insert data (or may insert 206 discardable data, for example) into a separate aggregated packet for another receiving device if there are not sufficient resources for both.

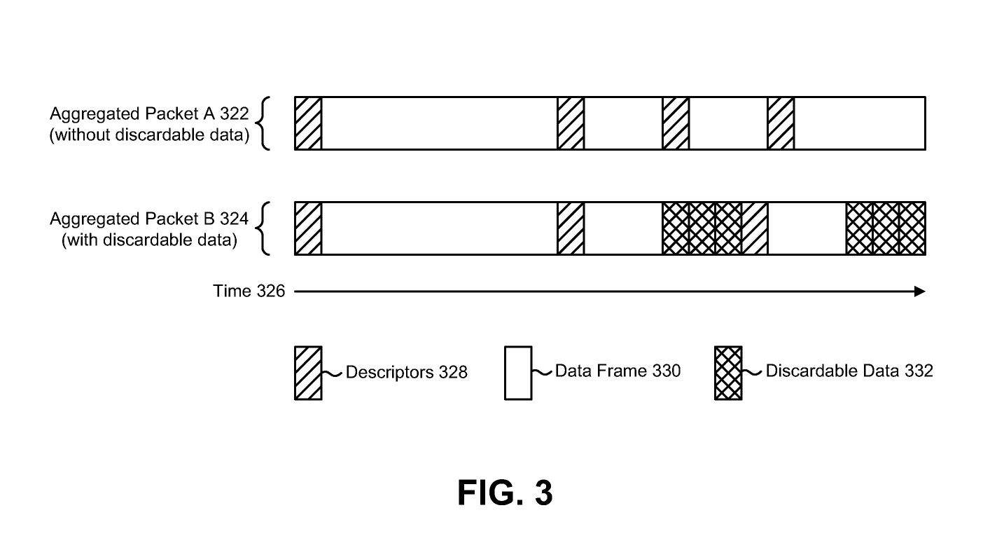

FIG. 3 is a diagram illustrating examples of aggregated packets 322, 324. In particular, aggregated packet A 322 and aggregated packet B 324 are illustrated over time 326. Aggregated packet A 322 includes several descriptors 328 and data frames 330. Aggregated packet B 324 includes discardable data 332 in addition to several descriptors 328 and data frames 330. Each descriptor 328 may include overhead data that describes the following data frame 330. For example, a descriptor 328 may include one or more of size information (e.g., length, timing, etc.), addressing information, encoding information and modulation information, etc., for the corresponding data frame 330. The data frames 330 may include payload data (e.g., voice call information, text, images, videos, other information, etc.). Examples of data frames 330 include MPDUs. Discardable data 332 may be data that may be discarded. For instance, the discardable data 332 may not include useful information. Examples of discardable data 332 include dummy information, dummy packets, null delimiters, null descriptors, null frames, MPDU-like frames with corrupted CRC, etc.

Aggregated packet A 322 is one example of a case where regular transmissions may continue while no discardable data is utilized. In aggregated packet A 322, four descriptors 328 and four data frames 330 are illustrated. For example, the first descriptor 328 in aggregated packet A 322 may include information that describes the content of the (following) first data frame 330. The one or more descriptors 328 and data frames 330 may be generated and/or transmitted from a communication device 102 while the communication device 102 has sufficient resources available to insert data into aggregated packet A 322.

Aggregated packet B 324 is one example of a case where discardable data that may be utilized in accordance with the systems and methods disclosed herein. For example, discardable data 332 may be inserted into aggregated packet B 324 when unexpectedly larger bus latencies, other overhead or resource shortages in between data frames 330 are experienced by a communication device 102. Instead of aborting the transmission, a communication device 102 may continue the transmission, but discardable data 332 may be inserted until enough data of the next data frame 330 is fetched to safely transmit again. Comparing aggregated packet A 322 and aggregated packet B 324, three data frames 330 instead of four may get transmitted in the same amount of medium time. While this is not ideal, at least these three data frames 330 were transmitted that could be correctly received. Furthermore, internal bus problems may not result in aborted transmissions. This example describes an adaptive/dynamic approach that is able to handle sudden (and typically rare) decreases in overall throughput from resource shortages (in the overall bus system and/or other resources, for example). As illustrated in FIG. 3, an aggregated packet 322, 324 may comprise one or more data frames 330, one or more descriptors 328 and/or discardable data 332. It should be noted that whether or not discardable data 332 is inserted, aggregated packet 322, 324 length may be the same in some configurations and/or instances.

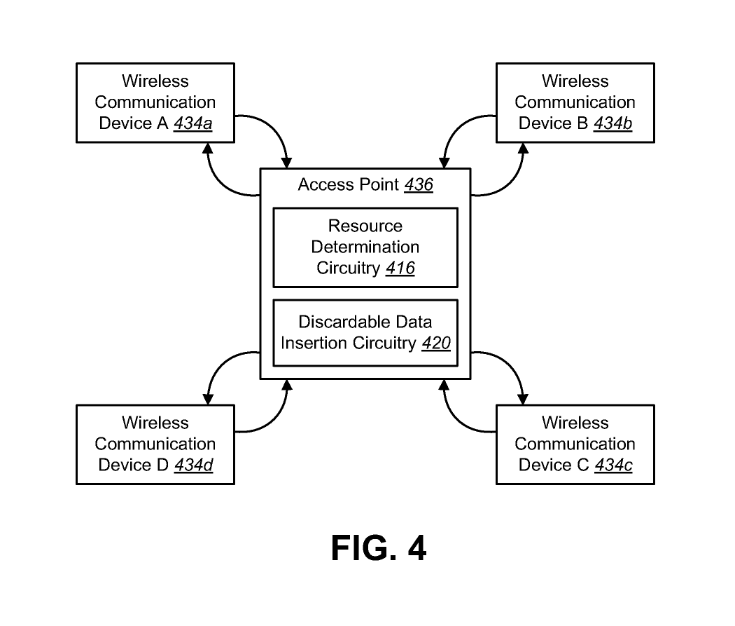

FIG. 4 is a block diagram illustrating one example of an access point 436 in which systems and methods for transmitting data based on available resources may be implemented. In particular, FIG. 4 illustrates an access point 436 and four wireless communication devices 434a-d. The access point 436 may be one example of the communication device 102 described in connection with FIG. 1. In some configurations, the access point 436 may be a Wi-Fi access point.

In the example illustrated in FIG. 4, the access point 436 may communicate with wireless communication devices 434a-d concurrently (e.g., in overlapping time frames). For example, the access point 436 may implement MU-MIMO in order to allow concurrent communications with multiple wireless communication devices 434a-d.

The access point 436 may include resource determination circuitry 416 and discardable data insertion circuitry 420. The resource determination circuitry 416 may be one example of the resource determination circuitry 116 described in connection with FIG. 1. The discardable data insertion circuitry 420 may be one example of the discardable data insertion circuitry 120 described in connection with FIG. 1. For instance, the discardable data insertion circuitry 420 may insert discardable data (e.g., dummy information, null delimiters, etc.) into one or more aggregated packets when the resource determination circuitry 416 determines that there are insufficient resources to insert data into the one or more aggregated packets. In some configurations, multiple aggregated packets may be concurrently transmitted, where each aggregated packet respectively corresponds to each wireless communication device 434a-d. In some implementations, each aggregated packet may be mapped to different channels, layers (e.g., spatial streams) and/or frequency bands.

Thus, when a shortage of one or more resources occurs (or is anticipated to occur) on the access point 436, discardable data may be transmitted to one or more of the wireless communication devices 434a-d. The one or more wireless communication devices 434a-d may disregard or discard the discardable data.

One scenario in which a resource shortage may occur is when the access point 436 is attempting to transmit multiple aggregated packets to multiple wireless communication devices 434a-d concurrently. In such a case, the access point 436 may insert discardable data in one or more of the aggregated packets (on one or more layers, frequency bands and/or channels, for example) for transmissions to the one or more wireless communication devices 434a-d. This may be done in the context of MU-MIMO, for instance.

In some configurations, one or more of the wireless communication devices 434a-d may additionally or alternatively be examples of the communication device 102 described in connection with FIG. 1. For example, wireless communication device A 434a may insert discardable data into an uplink aggregated packet when wireless communication device A 434a determines that insufficient resources are available to insert data (e.g., payload data) into the aggregated packet.

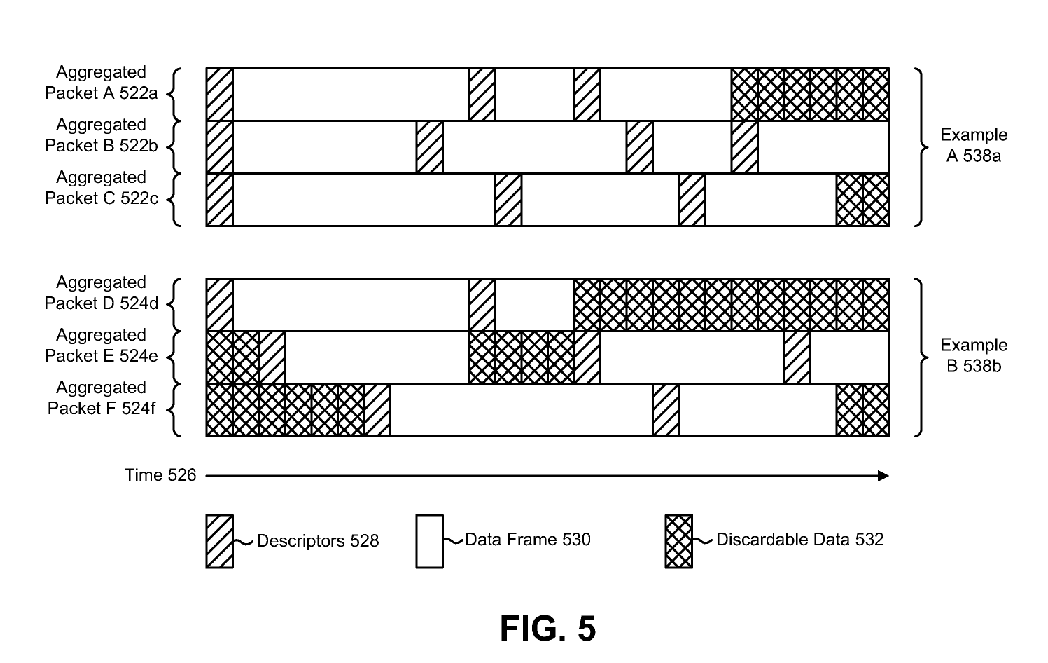

FIG. 5 is a diagram illustrating additional examples of aggregated packets 522a-c, 524d-f. In particular, aggregated packets 522a-c, 524d-f are illustrated over time 526. Each aggregated packet 522a-c, 524d-f includes several descriptors 528 and data frames 530. Aggregated packets A, C and D-F 522a, 522c, 524d-f include discardable data 532 in addition to several descriptors 528 and data frames 530. Each descriptor 528 may include overhead data that describes the following data frame 530. For example, a descriptor 528 may include one or more of size information (e.g., length, timing, etc.), addressing information, encoding information and modulation information, etc., for the corresponding data frame 530. The data frames 530 may include payload data (e.g., voice call information, text, images, videos, other information, etc.). Examples of data frames 530 include MPDUs. Discardable data 532 may be data that may be discarded. For instance, the discardable data 532 may not include useful information. Examples of discardable data 532 include dummy information, dummy packets, null delimiters, null descriptors, null frames, MPDU-like frames with corrupted CRC, etc.

In example A 538a, each of three concurrent aggregated packets 522a-c may be respectively transmitted to three separate devices. For example, aggregated packets A-C 522a-c may be concurrently and respectively transmitted to one or more separate devices (e.g., wireless communication devices) on separate channels, layers (e.g., spatial streams) and/or frequency bands. For instance, a communication device (e.g., base station, access point, etc.) may transmit aggregated packets A-C 522a-c by utilizing MU-MIMO techniques. MU-MIMO techniques have created more and stricter requirements on communication device resources (e.g., bus latencies). In example A 538a, MU-MIMO transmissions (e.g., aggregated packets A-C 522a-c) may be sent to three separate wireless communication devices in parallel. Especially for the first frame transmission, data for three data frames 530 (e.g., MPDUs) may have to be fetched for parallel transmission. This may demand possibly three times as much startup/initialization time when compared to a single user transmission (as illustrated in FIG. 3, for example).

Example B 538b is one example of a case where discardable data that may be utilized in accordance with the systems and methods disclosed herein. For example, discardable data 532 may be inserted into aggregated packets D-F 524d-f when unexpectedly larger bus latencies, other overhead or resource shortages are experienced by a communication device 102. Instead of aborting the transmission, a communication device 102 may continue the transmission, but discardable data 532 may be inserted until enough data of another data frame 530 is fetched to safely transmit again.

In example B 538b, each of three concurrent aggregated packets 524d-f may be respectively transmitted to three separate devices (using MU-MIMO techniques, for instance). For example, aggregated packets D-F 524d-f may be concurrently and respectively transmitted to separate devices (e.g., wireless communication devices) on separate channels, layers (e.g., spatial streams) and/or frequency bands. In order to allow more flexibility in being able to handle variations in bus latencies, for example, discardable data 532 may be utilized (e.g., inserted) during transmissions. It should be noted that whether or not discardable data 532 is inserted, aggregated packet 522, 524 length may be the same in some configurations and/or instances. For instance, inserting discardable data 532 may not extend the overall length of an aggregated 524d-f packet in some configurations.

Discardable data 532 may be inserted to cover resource shortages (e.g., bus latencies, transmit latencies, etc.). In example B 538b, discardable data 532 is inserted at the start of aggregated packets E-F 524e-f (for transmission to separate devices) in order to relax or cover initial data start fetch times for the aggregated packets 524d-f.

In some configurations, the usage (e.g., amount) of the discardable data may be predetermined based on overall system knowledge. This is considered to be a ‘static’ approach. Alternatively, discardable data may be inserted dynamically during transmission, when a longer data fetch time then normal occurs. Instead of aborting the transmission or having a corrupted data transmission, the discardable data may be inserted at a “last moment” to alleviate these potential problems. Implementing the dynamic approach may create an extra amount of transmission robustness for a communication device. It should be noted that the static or dynamic approaches may be applied to single aggregated packets (e.g., single-user transmissions) as well as multiple concurrent aggregated packets (e.g., multi-user transmissions).

The usage of a static and/or dynamic approach may be detected on the medium when observing multiple frame packet transmissions. When discardable data are observed consistently and in the same amounts in the same spots with the same packet sizes, the static mechanism may be in use. A dynamic approach may be indicated when the usage of discardable data changes from one transmission to another with the same data sizes (sometimes none, and other times more). Thus, the systems and methods disclosed herein may allow statically or dynamically inserting discardable data (e.g., dummy frame delimiters similar to null delimiters in WLAN) during transmissions when data underflow scenarios in between frames are expected or about to occur.

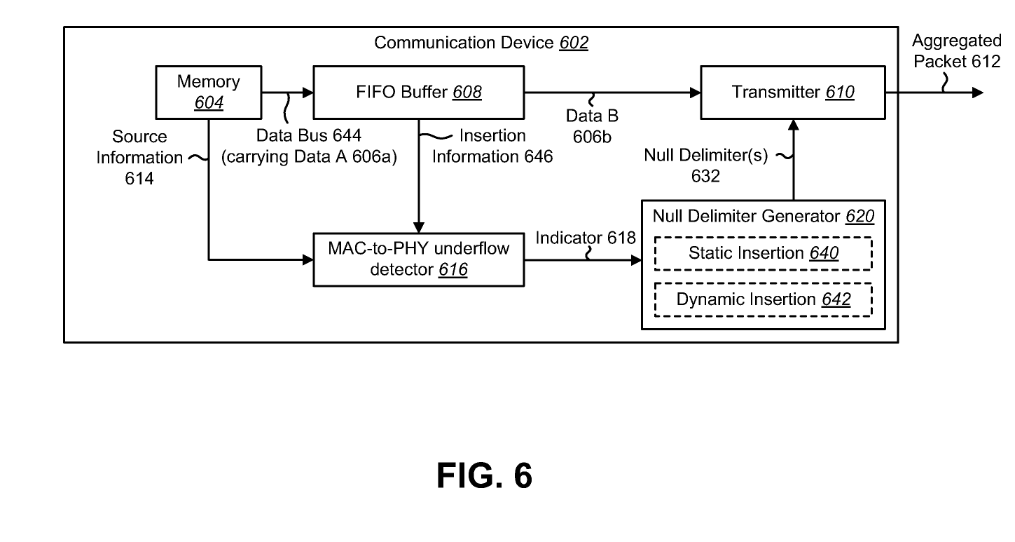

FIG. 6 is a block diagram illustrating a more specific configuration of a communication device 602 in which systems and methods for transmitting data based on available resources may be implemented. Examples of the communication device 602 include wireless communication devices, base stations, access points, smart phones, laptop computers, desktop computers, tablet devices, gaming systems, e-readers, personal digital assistants, netbooks, wireless routers, etc. The communication device 602 may include a memory 604, data bus 644, FIFO buffer 608, MAC-to-PHY underflow detector 616, null delimiter generator 620 and/or one or more transmitters 610.

One example of the memory 604 is double data rate (DDR) memory. The memory 604 may supply data A 606a to the FIFO buffer 608. For example, data A 606a may be payload data for transmission to another device. Data A 606a may be carried on the data bus 644 to the FIFO buffer 608.

In some configurations, the memory 604 may provide source information 614 to the MAC-to-PHY underflow detector 616. The source information 614 may be one or more types of information regarding the memory 604 and/or data utilized by the memory 604. For example, the source information 614 may specify an amount of data designated for transmission, how full the memory 604 is (e.g., an amount of occupied memory), a loading factor (e.g., memory load), output rate, access speed, an indicator specifying that access speeds are slowing down or are anticipated to slow down, processes/applications currently running, one or more designated transmission data destinations (e.g., information that identifies destination devices such as Internet Protocol (IP) addresses, Media Access Control (MAC) addresses, session information, etc.), a number of transmission data destinations, anticipated packet size, temperature, etc.

The FIFO buffer 608 may be circuitry that inserts data A 606a into one or more packets for transmission. For example, the FIFO buffer 608 may be a temporary FIFO buffer with a relatively small capacity (e.g., one one-hundredth of a typical aggregated packet size). The FIFO buffer 608 may insert data A 606a into one or more packets (e.g., aggregated packets). Data A 606a may be inserted into one or more packets along with overhead data (e.g., descriptors). The FIFO buffer 608 may provide data B 606b to the transmitter 610 for transmission. It should be noted that data B 606b may include all of or a subset of data A 606a. In addition, data B 606b may include overhead data (e.g., descriptors, packet headers, etc.).

The FIFO buffer 608 may provide insertion information 646 to the MAC-to-PHY underflow detector 616. The insertion information 646 may be one or more types of information regarding data insertion. For example, the insertion information 646 may specify a FIFO buffer load (e.g., how empty or full the FIFO is), input rate, output rate, bus latency, packet size, number of frames, number of aggregated packets, number of packet destinations, an amount of overhead data, a ratio of overhead data to payload data, etc.

The MAC-to-PHY underflow detector 616 may determine whether there are sufficient resources available to insert data (e.g., payload data) into one or more aggregated packets. In particular, the MAC-to-PHY underflow detector 616 may detect MAC-to-PHY underflow: whether there are not sufficient resources available move MAC layer data to the PHY layer (e.g., into an aggregated packet) in order to keep up with the PHY layer data rate. In other words, the MAC-to-PHY underflow detector 616 may detect whether MAC-to-PHY underflow has occurred, is occurring and/or is anticipated to occur. Examples of resources include bus bandwidth, memory bandwidth, processor bandwidth and/or fetched data, etc. This determination may be made based on the source information 614, the insertion information 646, and/or other information. For example, the MAC-to-PHY underflow detector 616 may detect MAC-to-PHY underflow if the data bus on the communication device 602 cannot fetch data fast enough to insert data, if there is insufficient memory currently available to insert data, if a processor's current load is too high to insert data, when data for a frame cannot be generated (e.g., calculated) rapidly enough to be inserted, if not enough data has been fetched for a frame, etc.

For example, the MAC-to-PHY underflow detector 616 may receive a FIFO buffer load (e.g., how much data is in the FIFO, a percentage load) as insertion information 646. If the FIFO buffer load is below a threshold (e.g., less than a particular amount of data or under a percentage), then the MAC-to-PHY underflow detector 616 may detect MAC-to-PHY underflow.

Additionally or alternatively, for example, the MAC-to-PHY underflow detector 616 may receive a memory load (e.g., an amount of occupied memory) as source information 614. The MAC-to-PHY underflow detector 616 may detect MAC-to-PHY underflow if the memory load is above a threshold (e.g., greater than a particular amount of data or greater than a percentage). In some configurations, the MAC-to-PHY underflow detector 616 may detect MAC-to-PHY underflow if the memory is occupied by one or more particular (memory-intensive) applications, which may be identified by the source information 614, for instance.

Additionally or alternatively, for example, the MAC-to-PHY underflow detector 616 may receive a percentage of overhead data (e.g., how much of the data in the FIFO is overhead data versus payload data) as insertion information 646. The MAC-to-PHY underflow detector 616 may detect MAC-to-PHY underflow if the percentage of overhead data is above a threshold. This may occur in cases where the data frames are relatively small, resulting in a larger percentage of overhead data, for example.

The MAC-to-PHY underflow detector 616 may provide an indicator 618 to the null delimiter generator 620. The indicator 618 may be based on whether MAC-to-PHY underflow is detected by the MAC-to-PHY underflow detector 616. For example, the indicator 618 may indicate that MAC-to-PHY underflow is detected (or anticipated, for example). Additionally or alternatively, the indicator 618 may indicate an amount of discardable data to insert.

The null delimiter generator 620 may generate and insert one or more null delimiters 632 based on the indicator 618. For example, the null delimiter generator 620 may generate and insert one or more null delimiters 632 into data B 606b (e.g., an aggregated packet) if the indicator 618 indicates MAC-to-PHY underflow. For instance, the one or more null delimiters 632 may be provided to the transmitter 610, which may transmit data B 606b in combination with the one or more null delimiters 632. A device that receives the one or more null delimiters 632 may disregard or discard the one or more null delimiters 632.

The transmitter 610 may transmit one or more aggregated packets 612. For example, the transmitter 610 may transmit one or more aggregated packets 612 based on wireless communication technology, wired communication technology or both. For example, the communication device 602 may transmit data to one or more other devices using one or more antennas on one or more frequency bands, time slots, layers (e.g., spatial streams), etc. In other configurations of the systems and methods disclosed herein, wired communications may be used in addition to or alternatively to wireless communications. In some implementations, the communication device 602 may operate in accordance with Wi-Fi specifications. In these implementations, the transmitter 610 may wirelessly transmit one or more aggregated packets 612 using one or more antennas.

In some configurations and/or cases, one or more null delimiters 632 may be inserted after transmission has begun (e.g., during an ongoing transmission). For example, the transmitter 610 may have begun transmitting an aggregated packet 612 when the MAC-to-PHY underflow detector 616 determines that there are not sufficient resources available to insert data into part of the aggregated packet 612 (that has not yet been transmitted, for example) (e.g., detects MAC-to-PHY underflow). Accordingly, the null delimiter generator 620 may insert discardable data into data B 606b (at a “last moment”). This may be done instead of aborting the transmission or having a corrupted data (e.g., payload data) transmission.

In some configurations, the null limiter generator 620 may include one or more of a static insertion block and/or module 640 and a dynamic insertion block and/or module 642. The static insertion block and/or module 640 may insert discardable data (e.g., null delimiter(s) 632) into an aggregated packet in accordance with a static approach. In one example of the static approach, predetermined amounts of discardable data may be inserted based on overall system knowledge. In the static approach, the insertion of discardable data may be consistently utilized. For example, if a particular memory-intensive application is running, the communication device 602 may determine that there are not sufficient resources available to insert data into an aggregated packet and may insert a predetermined amount of discardable data into the aggregated packet.

For example, the static insertion block and/or module 640 may insert one or more fixed amounts of discardable data (e.g., null delimiter(s) 632) based on overall communication device 602 information. For instance, if a certain application has started running, if the communication device 602 is transmitting a given number of aggregated packets in parallel, etc., a predetermined number of null delimiters 632 may be automatically inserted. In this way, discardable data (e.g., null delimiter(s) 632) may be predetermined and inserted “up front.” In some cases, the discardable data (e.g., null delimiter(s) 632) may be inserted before transmission of the data (e.g., data frame, payload data) begins.

The dynamic insertion block and/or module 642 may insert discardable data (e.g., null delimiter(s) 632) into an aggregated packet in accordance with a dynamic approach. In a dynamic approach, the amount of discardable data (e.g., null delimiter(s) 632) inserted may not be predetermined. For example, the amount of discardable data inserted may vary based on available resources. For instance, the communication device 602 may determine that there are not sufficient resources available to insert data (e.g., payload data) into an aggregated packet when the FIFO buffer 608 load is below a threshold. Discardable data may be inserted until the FIFO buffer 608 load is greater than a threshold. Thus, the usage of discardable data may change from one kind of transmission to another.

In some configurations, only the static insertion approach may be utilized (e.g., only the static insertion block and/or module 640 may be included in the communication device 602). In other configurations, only the dynamic insertion approach may be utilized (e.g., only the dynamic insertion block and/or module 642 may be included in the communication device 602). In yet other configurations, a combination of the static approach and the dynamic approach may be implemented. For example, the static insertion block and/or module 640 may insert predetermined amounts of discardable data (e.g., null delimiter(s) 632) “up front” when certain conditions are met or certain triggers occur. Furthermore, the dynamic insertion block/module 642 may insert discardable data (e.g., null delimiter(s) 632) when other conditions are met or other triggers occur. For instance, the static insertion block and/or module 640 may insert a predetermined amount of null delimiters 632 when a certain application is running and the dynamic insertion block and/or module 642 may insert one or more null delimiters 632 when the FIFO buffer 608 load is below a threshold.

Accordingly, a combination of static and dynamic approaches may be applied in some implementations. For example, the communication device 602 may switch between static and dynamic approaches. For instance, the communication device 602 may determine to switch between static and dynamic approaches based on conditions on the communication device 602 (e.g., transmission data type, applications currently running, processor load, memory 604 load, bus 644 load, FIFO buffer 608 load, number of concurrent aggregated packets, etc.) and/or input (from another device (e.g., receiving device) and/or a user). Additionally or alternatively, a hybrid of static and dynamic approaches may be implemented. For example, a static approach may be applied for certain transmission data types, while a dynamic approach may be applied for other transmission data types.

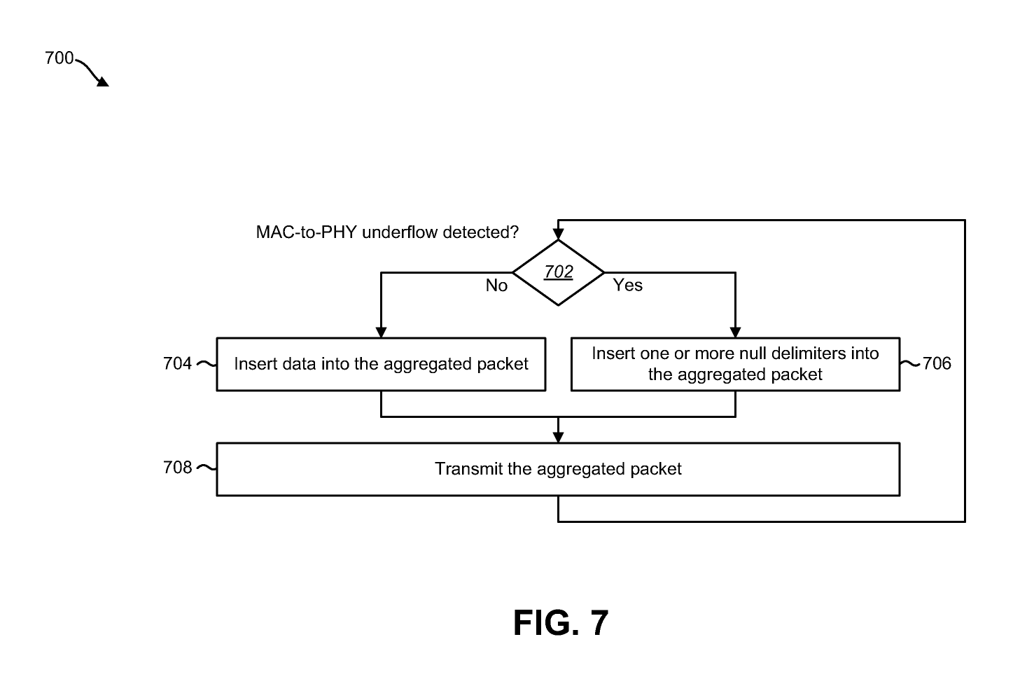

FIG. 7 is a flow diagram illustrating one configuration of a method 700 for transmitting data based on available resources by a communication device 602. A communication device 602 (e.g., base station, wireless communication device, access point, station, etc.) may determine 702 whether MAC-to-PHY underflow is detected. This may be done as described above in connection with FIG. 6 and/or as described above in connection with FIG. 2 for determining 202 whether there are sufficient resources available to insert data into an aggregated packet.

If MAC-to-PHY underflow is not detected (e.g., there are sufficient resources available to insert data into an aggregated packet), the communication device 602 may insert 704 data into the aggregated packet. For example, the communication device 602 may insert 704 overhead data (e.g., descriptors) and/or payload data into the aggregated packet. For instance, an access point may insert 704 a descriptor and/or data into an aggregated packet for transmission to a station.

If MAC-to-PHY underflow is detected (e.g., if there are not sufficient resources available to insert data into an aggregated packet), the communication device 602 may insert 706 one or more null delimiters into the aggregated packet. A MAC-to-PHY underflow may be detected when there is insufficient bus bandwidth, memory bandwidth, processor bandwidth and/or fetched data, etc.

In some configurations and/or cases, the one or more null delimiters 632 may be inserted 706 after transmission has begun (e.g., during an ongoing transmission). For example, the transmitter 610 may have begun transmitting an aggregated packet 612 when the communication device 602 detects 702 a MAC-to-PHY underflow for part of the aggregated packet 612 (that has not yet been transmitted, for example). Accordingly, the communication device 602 may insert 706 one or more null delimiters into data B 606b (at a “last moment”). This may be done instead of aborting the transmission or having a corrupted data (e.g., payload data) transmission.

The communication device 602 may transmit 708 the aggregated packet. For example, the transmitter 610 may transmit all or a portion of one or more aggregated packets 612 based on wireless communication technology, wired communication technology or both. For example, the communication device 602 may transmit data to one or more other devices using one or more antennas on one or more frequency bands, time slots, layers (e.g., spatial streams), etc. In other configurations of the systems and methods disclosed herein, wired communications may be used in addition to or alternatively from wireless communications. In some implementations, the communication device 602 may operate in accordance with Wi-Fi specifications. In these implementations, the transmitter 610 may wirelessly transmit one or more aggregated packets 612 using one or more antennas.

The communication device 602 may return to determine 702 whether a MAC-to-PHY underflow is detected. In some configurations, the communication device 602 may accordingly continue to insert 706 null delimiters 632 into an aggregated packet if and until MAC-to-PHY underflow is not detected (e.g., there are sufficient resources available to insert 704 data into the aggregated packet). It should be noted that data for the aggregated packet may include overhead data (e.g., descriptors) for the frame and/or payload data.

In some implementations, inserting 706 one or more null delimiters 632 into an aggregated packet may be performed based on a static approach or a dynamic approach. In one example of the static approach, predetermined amounts of null delimiters 632 may be inserted 706 based on overall system knowledge. In the static approach, the insertion 706 of null delimiters 632 may be consistently utilized. For example, if a particular memory-intensive application is running, the communication device 602 may determine 702 that MAC-to-PHY underflow is detected (e.g., there are not sufficient resources available to insert data into an aggregated packet) and may insert 706 a predetermined amount of null delimiters 632 into the aggregated packet.

In a dynamic approach, the amount of null delimiters 632 inserted 706 may not be predetermined. For example, the amount of null delimiters 632 inserted 706 may vary based on available resources. For instance, the communication device 602 may determine 702 that a MAC-to-PHY underflow is detected (e.g., there are not sufficient resources available to insert data into an aggregated packet) when a FIFO buffer 608 load is below a threshold. One or more null delimiters 632 may be inserted 706 until the FIFO buffer 608 load is greater than a threshold. Thus, the usage of discardable data may change from one kind of transmission to another.

In some configurations, the communication device 602 may insert 704 data and/or may insert 706 one or more null delimiters 632 into one or more of multiple aggregated packets. This may be done when the communication device 602 is simultaneously transmitting to multiple devices on one or more frequency bands, layers (e.g., spatial streams) and/or channels, for example. In some cases, the communication device 602 may selectively insert 704 data for into an aggregated packet for one receiving device, but may not insert data (or may insert 706 null delimiters 632, for example) into a separate aggregated packet for another receiving device if there are not sufficient resources for both.

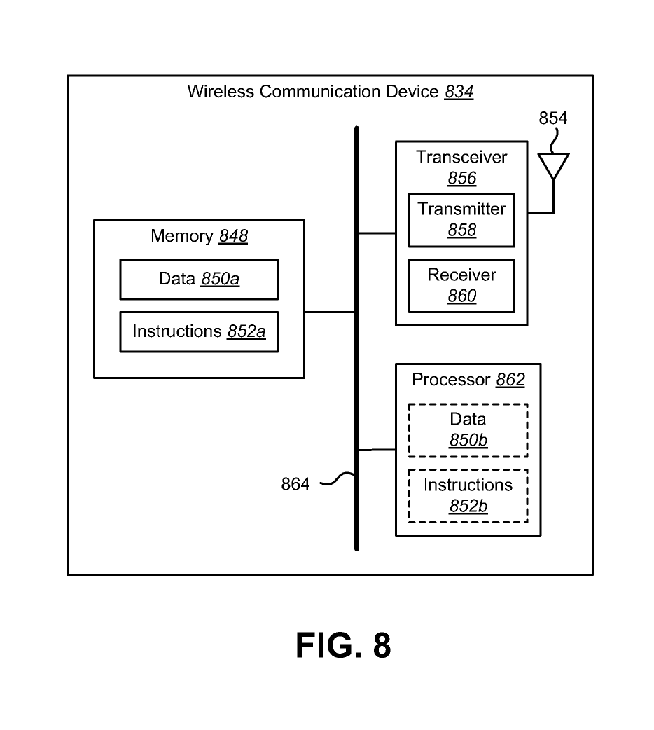

FIG. 8 illustrates certain components that may be included within a wireless communication device 834. One or more of the communication devices 102, 602 and wireless communication devices 434 described above may be implemented in accordance with the wireless communication device 834 described in connection with FIG. 8. The wireless communication device 834 includes a processor 862. The processor 862 may be a general purpose single- or multi-chip microprocessor (e.g., an ARM), a special purpose microprocessor (e.g., a digital signal processor (DSP)), a microcontroller, a programmable gate array, etc. The processor 862 may be referred to as a central processing unit (CPU). Although just a single processor 862 is shown in the wireless communication device 834 of FIG. 8, in an alternative configuration, a combination of processors (e.g., an ARM and DSP) could be used.

The wireless communication device 834 also includes memory 848 in electronic communication with the processor 862 (i.e., the processor 862 can read information from and/or write information to the memory 848). The memory 848 may be any electronic component capable of storing electronic information. The memory 848 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 850a and instructions 852a may be stored in the memory 848. The instructions 852a may include one or more programs, routines, sub-routines, functions, procedures, etc. The instructions 852a may include a single computer-readable statement or many computer-readable statements. The instructions 852a may be executable by the processor 862 to implement one or more of the methods 200, 700 that were described above. Executing the instructions 852a may involve the use of the data 850a that is stored in the memory 848. FIG. 8 shows some instructions 852b and data 850b being loaded into the processor 862.

The wireless communication device 834 may also include a transmitter 858 and a receiver 860 to allow transmission and reception of signals between the wireless communication device 834 and a remote location (e.g., a base station or other wireless communication device). The transmitter 858 and receiver 860 may be collectively referred to as a transceiver 856. An antenna 854 may be electrically coupled to the transceiver 856. The wireless communication device 834 may also include (not shown) multiple transmitters, multiple receivers, multiple transceivers and/or multiple antenna.

The various components of the wireless communication device 834 may be coupled together by one or more buses, which may include a power bus, a control signal bus, a status signal bus, a data bus, etc. For simplicity, the various buses are illustrated in FIG. 8 as a bus system 864.

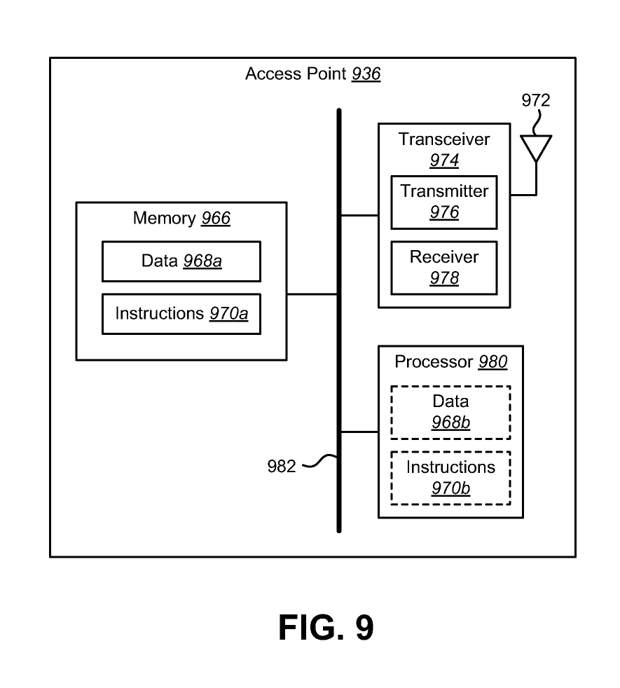

FIG. 9 illustrates certain components that may be included within an access point 936. One or more of the communication devices 102, 602 and access point 436 described above may be implemented in accordance with the access point 936 described in connection with FIG. 9. The access point 936 includes a processor 980. The processor 980 may be a general purpose single- or multi-chip microprocessor (e.g., an ARM), a special purpose microprocessor (e.g., a digital signal processor (DSP)), a microcontroller, a programmable gate array, etc. The processor 980 may be referred to as a central processing unit (CPU). Although just a single processor 980 is shown in the access point 936 of FIG. 9, in an alternative configuration, a combination of processors (e.g., an ARM and DSP) could be used.

The access point 936 also includes memory 966 in electronic communication with the processor 980 (i.e., the processor 980 can read information from and/or write information to the memory 966). The memory 966 may be any electronic component capable of storing electronic information. The memory 966 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 968a and instructions 970a may be stored in the memory 966. The instructions 970a may include one or more programs, routines, sub-routines, functions, procedures, etc. The instructions 970a may include a single computer-readable statement or many computer-readable statements. The instructions 970a may be executable by the processor 980 to implement one or more of the methods 200, 700 described above. Executing the instructions 970a may involve the use of the data 968a that is stored in the memory 966. FIG. 9 shows some instructions 970b and data 968b being loaded into the processor 980.

The access point 936 may also include a transmitter 976 and a receiver 978 to allow transmission and reception of signals between the access point 936 and a remote location (e.g., a wireless communication device). The transmitter 976 and receiver 978 may be collectively referred to as a transceiver 974. An antenna 972 may be electrically coupled to the transceiver 974. The access point 936 may also include (not shown) multiple transmitters, multiple receivers, multiple transceivers and/or multiple antenna.

The various components of the access point 936 may be coupled together by one or more buses, which may include a power bus, a control signal bus, a status signal bus, a data bus, etc. For simplicity, the various buses are illustrated in FIG. 9 as a bus system 982.

In the above description, reference numbers may have been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for transmitting data by a communication device, comprising:
determining whether there are sufficient resources available to insert data into an aggregated packet;
inserting discardable data into the aggregated packet if there are not sufficient resources available to insert the data; and
inserting the data into the aggregated packet if there are sufficient resources available to insert the data.

2. The method of claim 1, further comprising transmitting the aggregated packet.

3. The method of claim 1, wherein the discardable data is inserted based on a static approach.

4. The method of claim 1, wherein the discardable data is inserted based on a dynamic approach.

5. The method of claim 1, wherein determining whether there are sufficient resources available to insert data into the aggregated packet comprises detecting media access control (MAC) layer to physical (PHY) layer underflow.

6. The method of claim 1, wherein determining whether there are sufficient resources is performed for one or more aggregated packets corresponding to one or more devices.

7. The method of claim 1, wherein the discardable data comprises at least one of a group consisting of a null delimiter, a null descriptor, dummy information, a dummy packet, a Quality of Service (QoS) null frame and a media access control (MAC) protocol data unit (MPDU)-like frame with an intentionally corrupted cyclic redundancy check (CRC).

8. The method of claim 1, wherein the data is at least part of a media access control (MAC) protocol data unit (MPDU).

9. The method of claim 1, wherein determining whether there are sufficient resources available to insert data into an aggregated packet is based on at least one of a group consisting of first in first out (FIFO) buffer load, memory load, bus latency and an amount of overhead data.

10. The method of claim 1, wherein the communication device is one of a group consisting of an access point and a wireless communication device.

11. A communication device for transmitting data, comprising:
resource determination circuitry that determines whether there are sufficient resources available to insert data into an aggregated packet;
discardable data insertion circuitry coupled to the resource determination circuitry, wherein the discardable data insertion circuitry inserts discardable data into the aggregated packet if there are not sufficient resources available to insert data; and
data insertion circuitry that inserts data into the aggregated packet if there are sufficient resources available to insert the data.

12. The communication device of claim 11, further comprising a transmitter that transmits the aggregated packet.

13. The communication device of claim 11, wherein the discardable data is inserted based on a static approach.

14. The communication device of claim 11, wherein the discardable data is inserted based on a dynamic approach.

15. The communication device of claim 11, wherein determining whether there are sufficient resources available to insert data into the aggregated packet comprises detecting media access control (MAC) layer to physical (PHY) layer underflow.

16. The communication device of claim 11, wherein determining whether there are sufficient resources is performed for one or more aggregated packets corresponding to one or more devices.

17. The communication device of claim 11, wherein the discardable data comprises at least one of a group consisting of a null delimiter, a null descriptor, dummy information, a dummy packet, a Quality of Service (QoS) null frame and a media access control (MAC) protocol data unit (MPDU)-like frame with an intentionally corrupted cyclic redundancy check (CRC).

18. The communication device of claim 11, wherein the data is at least part of a media access control (MAC) protocol data unit (MPDU).

19. The communication device of claim 11, wherein determining whether there are sufficient resources available to insert data into an aggregated packet is based on at least one of a group consisting of first in first out (FIFO) buffer load, memory load, bus latency and an amount of overhead data.

20. The communication device of claim 11, wherein the communication device is one of a group consisting of an access point and a wireless communication device.

21. A computer-program product for transmitting data, comprising a non-transitory tangible computer-readable medium having instructions thereon, the instructions comprising:
code for causing a communication device to determine whether there are sufficient resources available to insert data into an aggregated packet;
code for causing the communication device to insert discardable data into the aggregated packet if there are not sufficient resources available to insert the data; and
code for causing the communication device to insert the data into the aggregated packet if there are sufficient resources available to insert the data.

22. The computer-program product of claim 21, wherein the discardable data is inserted based on a static approach.

23. The computer-program product of claim 21, wherein the discardable data is inserted based on a dynamic approach.

24. The computer-program product of claim 21, wherein the code for causing the communication device to determine whether there are sufficient resources available to insert data into the aggregated packet comprises code for causing the communication device to detect media access control (MAC) layer to physical (PHY) layer underflow.

25. The computer-program product of claim 21, wherein determining whether there are sufficient resources is performed for one or more aggregated packets corresponding to one or more devices.

26. The computer-program product of claim 21, wherein the discardable data comprises at least one of a group consisting of a null delimiter, a null descriptor, dummy information, a dummy packet, a Quality of Service (QoS) null frame and a media access control (MAC) protocol data unit (MPDU)-like frame with an intentionally corrupted cyclic redundancy check (CRC).

27. The computer-program product of claim 21, wherein code for causing the communication device to determine whether there are sufficient resources available to insert data into an aggregated packet is based on at least one of a group consisting of first in first out (FIFO) buffer load, memory load, bus latency and an amount of overhead data.

28. An apparatus for transmitting data, comprising:
means for determining whether there are sufficient resources available to insert data into an aggregated packet;
means for inserting discardable data into the aggregated packet if there are not sufficient resources available to insert the data; and
means for inserting the data into the aggregated packet if there are sufficient resources available to insert the data.

29. The apparatus of claim 28, wherein the discardable data is inserted based on a static approach.

30. The apparatus of claim 28, wherein the discardable data is inserted based on a dynamic approach.

31. The apparatus of claim 28, wherein the means for determining whether there are sufficient resources available to insert data into the aggregated packet comprises means for detecting media access control (MAC) layer to physical (PHY) layer underflow.

32. The apparatus of claim 28, wherein determining whether there are sufficient resources is performed for one or more aggregated packets corresponding to one or more devices.

33. The apparatus of claim 28, wherein the discardable data comprises at least one of a group consisting of a null delimiter, a null descriptor, dummy information, a dummy packet, a Quality of Service (QoS) null frame and a media access control (MAC) protocol data unit (MPDU)-like frame with an intentionally corrupted cyclic redundancy check (CRC).

34. The apparatus of claim 28, wherein the means for determining whether there are sufficient resources available to insert data into an aggregated packet is based on at least one of a group consisting of first in first out (FIFO) buffer load, memory load, bus latency and an amount of overhead data.
